(19) United States
(12) Patent Application Publication
(10) Pub. No.: US 2009/0025170 A1
(43) Pub. Date: Jan. 29, 2009

(54) Dual Mode Motor Controller For a Vehicle Window Wiper System

(76) Inventors: Vernon D. Price, Springfield, TN (US); Alex Irkliy, Portland, TN (US)

Correspondence Address: WADDEY & PATTERSON, P.C., 1600 DIVISION STREET, SUITE 500, NASHVILLE, TN, 37203, US

(21) Appl. No.: 11/665,203

(22) PCT Filed: Oct. 14, 2005
(86) PCT No.: PCT/US05/37188

§ 371 Date: May 2, 2008

Related U.S. Application Data
(60) Provisional application No. 60/619,481, filed on Oct. 15, 2004.

(51) Int. Cl. B60S 1/08; H02P 7/00

(52) U.S. Cl. 15/250.12; 388/815

(57) ABSTRACT

A vehicle windshield wiper motor controller (10) includes a control circuit (15) and a power circuit. The power circuit can operate in dual modes, using a low cost MOSFET as the power switch during normal operation of the wiper motor, and a relay as the power switch during motor lugging and stall conditions. The controller (10) is part of a vehicle wiper system which includes a conventional wiper blade assembly positioned on the vehicle to engage the windshield or other window surface.

### TECHNICAL FIELD

The present invention relates generally to reciprocating wiper systems used to clear the front and rear windows of motor vehicles. More specifically, this invention pertains to circuits that control and provide operating current to vehicle wiper motors.

### BACKGROUND ART

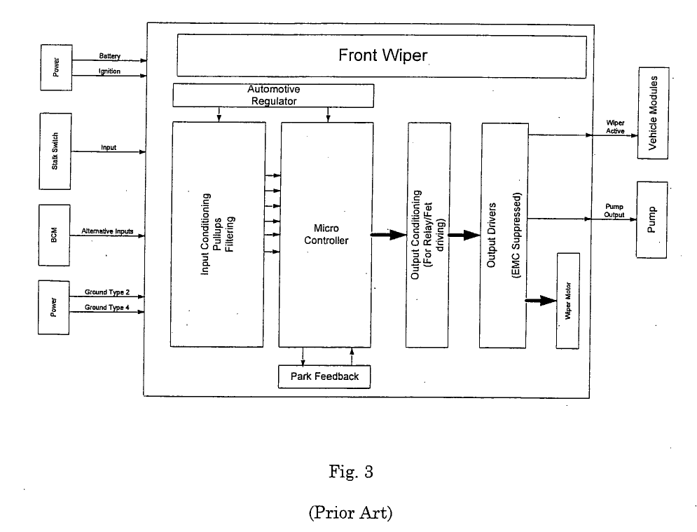

Automobiles, trucks, and many other vehicles use reciprocating wiper systems to clear rain, snow, ice, and dirt from their front windshields and often their rear windows as well. Typically, these wiper systems employ one or more 12 v DC motors to actuate the wiper blade assemblies. Most vehicle wiper systems can be manually switched by the vehicle operator to operate in slow, fast, and time variable intermittent modes. Accordingly, most vehicle wiper systems include a motor controller that generally combines a power circuit and a control circuit. The power circuit includes a power switch that connects the vehicle 12 v DC bus to the motor to supply motor operating current. The control circuit responds to operating commands from the wiper system control switch (as adjusted by the vehicle operator) and, in accordance with logic defined in the control circuit, sends control signals to the power switch, thereby determining when, and in what manner, the motor is to receive operating current. A block diagram of a typical windshield wiper/washer system is shown in FIG. 3.

During normal operation, the electric motors in vehicle wiper systems and power window systems will draw a nominal operating current over a predictable range. However, under certain conditions where movement of the wiper blade mechanism or window lift mechanism is restricted by window conditions, the motors are also subject to lugging and stall conditions. When an electric motor, such as a wiper motor, is lugging, the motor current can be seven times higher than normal. A stalled motor can draw as much as ten times its normal operating current. Thus, a 2 amp motor may draw 16 amps of current while lugging and up to 30 amps when the motor is stalled. Although a wiper motor is operating in a normal mode 95% of the time, lugging and stalling conditions cannot practically be avoided. Accordingly, the components in the power circuit that directly supply operating current to the motor must be capable of handling extreme current conditions.

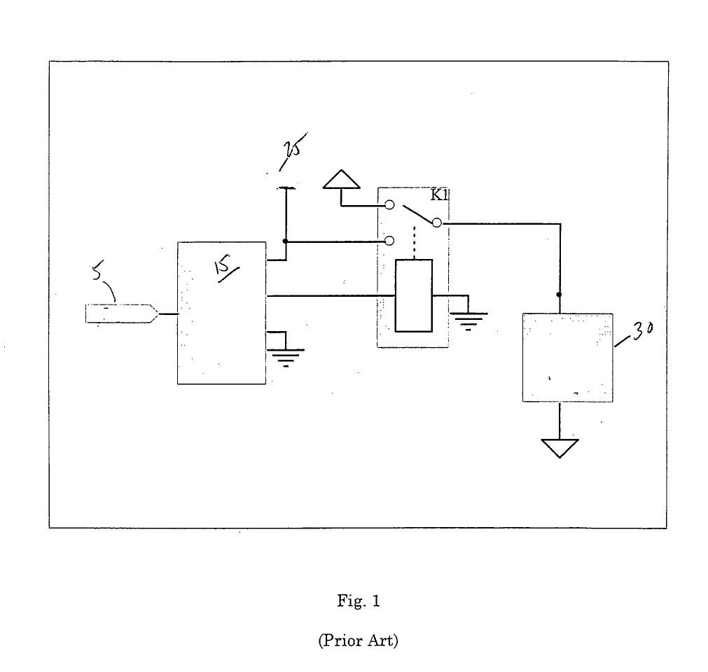

A conventional motor controller for a vehicle wiper system is shown in FIG. 1. The operating current is supplied from vehicle DC power bus 25 to the vehicle wiper motor 30. Operating current to the motor 30 is switched on and off by relay K1, in response to commands from the control circuit 15. The control circuit 15 is responsive to operating commands from the wiper system control switch (input 5), as activated by the vehicle operator.

Conventional wiper motor controllers typically switch the extreme range of wiper motor operating currents by using either an ultra-high power metal oxide semiconductor field effect transistor (MOSFET) or a relay as shown in FIG. 1. The ultra high power MOSFET solution is expensive. The power dissipated by a MOSFET is highly dependent on the R_{DS(on)} of the device. Power MOSFETS typically dissipate heat through a die directly attached to a thermally conductive substrate. To minimize heat generation, an ultra high power MOSFET used to drive a wiper motor must have a very low R_{DS(on)} (1-2 mOhm range) and/or be protected by a heat sink. For example, some power MOSFET's are mounted on flexible circuit boards attached to a heat sink with a heat conductive adhesive. In addition, metal core printed circuit boards are often used for improved heat conduction.

Using a relay as the power switch component in a wiper motor controller is ordinarily a less costly solution as compared to using an ultra high power MOSFET. Relays have very low contact resistance, reducing heat generation under the extreme current loads experienced during motor lugging and stalling. The metal structure associated with relays inherently provides additional heat sinking for high power applications. The disadvantage of relays is their mechanical operation. Relays have a defined mechanical life, which shortens if the relay is switched under load. Relays are also susceptible to contact material transfer (caused by switching under heavy loads) and to relay contact bounce. Also, when relays are switched under low level loads, the sliding of the contact surfaces causes polymerization of the organic compounds. Consequently, deposits with high, unstable resistance are left on the contacts.

What is needed, then, is a low cost motor controller for a wiper system that can reliably supply operating current to the wiper motor during normal operation and during lugging and stall conditions.

### DISCLOSURE OF THE INVENTION

The motor controller of the present invention takes advantage of the low cost of relays and the reliability of MOSFETS. In accordance with a preferred embodiment of the invention, the motor controller includes a control circuit and a power circuit. The power circuit can operate in dual modes, using a low cost MOSFET as the power switch during normal operation of the wiper motor, and a relay as the power switch during motor lugging and stall conditions. Thus, the vehicle wiper system of this invention includes a conventional wiper blade assembly positioned on the vehicle to engage the windshield or other window surface. A DC motor is operatively connected to the wiper assembly to cause reciprocating movement of the wiper blade across the window surface. The wiper motor is connected to a 12 v DC bus in the vehicle through the power circuit. The power circuit includes a solid state switch and a relay. The solid state switch and the relay are electrically connected in parallel to selectively supply motor current from the DC bus source to the motor through one or the other of the solid state switch and the relay. Preferably, the solid state switch is a low cost, high R_{DS(on)} MOSFET capable of supplying operating current to the motor under normal conditions without a heat sink. The relay is capable of supplying motor current when the motor is stalled or lugging. The power circuit further includes a current sensor, such as a shunt resistor, that is functional to sense changes in the motor current corresponding to normal motor operation, motor lugging, and motor stalling.

The control circuit can be a conventional controller IC. The control circuit is electrically coupled to the current sensor, to the relay, and to the solid state switch. The control circuit is also electrically coupled to the wiper control switch controlled by the vehicle operator. The control circuit includes logic that is responsive to the current sensor to selectively direct motor current through the solid state switch during normal motor operation and through the relay during motor lugging and motor stalling. In a preferred embodiment of the invention, the power circuit includes a second solid state switch connected across the motor to handle reverse motor currents when the motor is turned off.

FIG. 1 is a schematic diagram of a conventional wiper motor control circuit for a vehicle windshield wiper system.

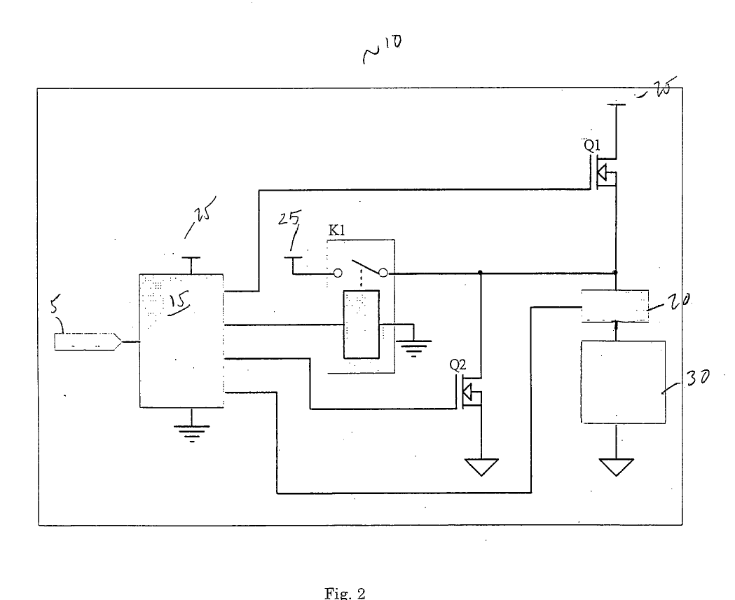

FIG. 2 is a schematic diagram of one embodiment of the dual mode motor controller for a vehicle wiper system in accordance with the present invention.

FIG. 3 is a block diagram of a typical vehicle windshield wiper system.

### BEST MODE FOR CARRYING OUT THE INVENTION

A schematic diagram of one embodiment of the wiper motor controller of the present invention is shown in FIG. 2. The controller 10 includes a control circuit 15 connected to a power circuit. The power circuit includes a first solid state switch Q1, a second solid state switch Q2, a relay K1, and a current sensor 20. Preferably, the first and second solid state switches Q1 and Q2 are MOSFET's. The drain terminal of the first solid state switch Q1 is coupled to the vehicle DC bus 25. The source terminal of Q1 is coupled to the wiper motor 30. The gate terminal of Q1 is connected to the control circuit 15. Thus, switching signals sent from the control circuit 15 to the gate of Q1 determine when and in what manner operating current is supplied from the DC bus 25 through Q1 to the motor 30.

The control circuit 15 is responsive to electrical signals from the wiper system control switch (input 5) 5 that is activated by the vehicle operator. Depending on the particular system and vehicle, these signals can cause the wiper to operate in slow, fast and intermittent modes and/or to activate a windshield cleaning pump, as shown on FIG. 3. The control circuit 15 can respond to other inputs as well for improved operation of the wiper system, also shown on FIG. 3. For simplicity of illustration and explanation of the subject invention, the details of other modules in the wiper system and other input/output connections to the control circuit 15 are not shown in FIG. 2. The control circuit can be a conventional controller IC such as a PIC16F688 (using appropriate interface circuitry not shown) or a custom ASIC application specific integrated circuit). Programming (software or firmware) of the logic functions as described herein is a straightforward task well understood by those of skill in the art.

One of the switched contacts of relay K1 is also connected to the DC bus 25. The other switched contact of relay K1 is electrically coupled to the motor 30. The solenoid of relay K1 is connected to the control circuit 15. Therefore, the relay K1 can also supply operating current to the motor 30 in response to switching signals sent to the relay solenoid by motor control circuit 15.

In the embodiment of FIG. 2, the second solid state switch Q2 is used to shunt reverse currents from the motor 30 that are generated when the motor 30 is shut down. In the other words, the primary function of Q2 is to provide a path for the current generated by the motor 30 so that the motor is dynamically braked when its positive terminal is effectively shorted to ground.

The current sensor 20 sends signals to the motor control circuit 15 that vary in proportion to the magnitude of the motor current. The motor control circuit 15 includes logic (hardware, software, or both) that responds to the motor current signals. When the current sensor 20 indicates that the motor current is within a nominal range corresponding to normal motor operation, the logic in the motor control circuit 15 causes the motor control circuit 15 to turn the solid state switch Q1 “on” and to open the relay K1. If the wiper motor 30 begins lugging or stalls, the current sensor 20 and logic in the motor control circuit 15 will close relay K1. This prevents the larger motor currents from continuously passing through Q1. Because Q1 will have an R_{DS(on)} that is higher than the on-resistance of relay K1, Q1 and K1 can safely share current during motor stall or lugging conditions, with most of the current flowing through K1. The current sensor 20 can be as simple as a shunt resistor that sends a variable voltage to the control circuit 15 that is proportional to the motor current. The logic in the motor control circuit 15 can then compare the magnitude of the voltage from the shunt resistor to one or more predetermined values that correspond to normal motor current, lugging current, and stall current.

Although using a MOSFET with a relatively high R_{DS(on)} will substantially reduce the cost of Q1 and facilitate proper current sharing between Q1 and relay K1 when the motor 30 is stalled or lugging, a low R_{DS(on)} device can also be used if desired. Depending on the ratio of R_{DS(on)} to the contact resistance of relay K1 in such an embodiment, it may be necessary to modify the logic of control circuit 15 to turn Q1 off entirely when the motor is stalled or lugging or to add (or switch) a very small supplemental resistance in series with Q1 to insure that the majority of the motor current passes through relay K1 when the motor is stalled or lugging.

Table 1 below is a state transition matrix that describes the sequence of switching events for Q1, Q2, and K1 as implemented by the logic in motor control circuit 15 in one embodiment of the motor controller 10. The controller 10 is initialized when power is applied, typically after the vehicle ignition switch (not shown) is turned on or when the wiper system switch (FIG. 3) is turned on by the vehicle operator. After the controller 10 is initialized, the vehicle wiper system is normally in the OFF state (input 5 “off”), with Q1 off and K1 open. No current is supplied to the motor 30. If the vehicle operator activates the wiper system using the wiper system control switch (input 5 “on”), the logic in the motor control circuit 15 moves from the OFF state (turning off second solid state switch Q2) through the DELAY_OFF_TO_ON state to the SOLID_STATE ON state, turning Q1 “on” after a delay period (to insure that second solid state switch Q2 is turned off) while relay K1 remains open. Thus, normal operating current is supplied to the motor 30 through solid state switch Q1, thereby activating the wiper assembly (FIG. 3).

During the SOLID_STATE ON mode, three separate switching conditions can arise. First, the wiper motor 30 can be deactivated, either manually by the vehicle operator (input 5 “off”) or by the motor control circuit 15 when timed intermittent wiper operation is desired. This action moves the motor controller 10 to an intermediate DELAY_ON_TO_OFF state, followed by the OFF state. During the DELAY_ON_TO_OFF state, Q1 is switched off, a timer is activated, and Q2 is turned on during the timer period to shunt reverse motor currents that occur when motor 30 is turned off and to dynamically brake the motor 30. If, during the SOLID_STATE_ON state, the current sensor 20 signals that the motor 30 is lugging or is stalled, the motor control circuit 15 closes relay K1, allowing the most of the higher motor current to flow through the relay K1 rather than through the first solid state switch Q1. By keeping Q1 on during all activations of relay K1, the damaging effect of high current switching on the relay contacts is reduced. The controller 10 is now in the COMPLEMENTARY_ON state. From the COMPLEMENTARY_ON state, if the wiper system is deactivated, the controller 10 moves through the COMPLEMENTARY_DELAY state, the DELAY_ON_TO_OFF state, and then to the OFF state, by opening K1 and turning on a timer to allow Q2 to shunt the reverse motor current.

TABLE 1

| State | Condition | Action | Next State |
|---|---|---|---|
| Initialize | | | OFF |
| SOLID_STATE_ON | Input = Off | Deactivate | DELAY_ON_TO_OFF |
| | | Q1 | |
| | Current = | Activate | COMPLEMENTARY_ON |
| | Lugging | Relay | |
| | Current = | Activate | COMPLEMENTARY_ON |
| | Stall | Relay | |
| DELAY_ON_TO_OFF | Timer > | Activate | OFF |
| | 20 ms | Q2 | |
| DELAY_OFF_TO_ON | Timer > | Activate | SOLID_STATE_ON |
| | 20 ms | Q1 | |
| COMPLEMENTARY_ON | Input = Off | Deactivate | COMPLEMENTARY_DELAY |
| | | Relay | |
| COMPLEMENTARY_DELAY | Timer > | Deactivate | DELAY_ON_TO_OFF |
| | 20 ms | Q1 | |
| OFF | Input = On | Deactivate | DELAY_OFF_TO_ON |
| | | Q2 | |

Note that the logic in the motor control circuit 15 can be configured to periodically pulse motor current to a stalled motor 30 to determine if the stalled condition is persistent and, if so, to eventually deactivate the controller 10 completely until it is re-initialized by a self-timer or by vehicle operator intervention.

In one embodiment of the motor controller 10, for driving a wiper motor 30 with a nominal 2 A operating current, a 16 A lugging current, and 25 A stall current, Q1 can be an International Rectifier IPS5451 MOSFET with an R_{DS(on)} in a range of 30-50 mOhms. Q2 can be an International Rectifier IRLF024N MOSFET, and relay K1 can be a Tyco V23086C2001A403. Motor control circuit 15 is preferably a PIC16F688 microcontroller IC.

By operating the motor controller 10 as described above, low cost solid state switches can be used for Q1 and Q2 because the relay K1 is handling the high current demands of a stalled or lugging wiper motor. The useful life of relay K1 is extended because it is operating only during abnormal motor conditions, because a second solid state switch Q2 is used to shunt destructive motor switching currents, and because Q1 minimizes hard switching of the relay. This life can be extended even more by including logic in the motor control circuit 15 that will periodically open and close relay K1 to clean the relay contacts.

In another embodiment of the invention, the current sensor 20 can be integral to the solid state switch Q1, thereby reducing component count. For example, the Infineon Technologies BTS443P MOSFET includes a current sensor and terminal in the device package.

Although the embodiment of the invention described herein is directed to control of a wiper motor in a vehicle window wiper system, is can also be used with other electric motors, such as power window motors, that draw nominal operating current in a normal running mode and substantially higher current under lugging or stall conditions.

Thus, although there have been described particular embodiments of the present invention of a new and useful “Dual Mode Motor Controller for a Vehicle Window Wiper System”, it is not intended that such references be construed as limitations upon the scope of this invention except as set forth in the following claims.

What is claimed is:

1. A wiper system for a windshield of a vehicle comprising:
a. a wiper element positioned on the vehicle to engage the windshield;
b. an electric motor operatively connected to the wiper element;
c. an electrical power source located in the vehicle;
d. a power circuit electrically connecting the power source to the motor, the power circuit including a solid state switch and a relay, the solid state switch and the relay electrically connected in parallel to selectively supply motor current from the power source to the motor through one or the other of the solid state switch and the relay or through both of the solid state switch and the relay;
e. the power circuit further comprising a current sensor functional to sense changes in the motor current corresponding to normal motor operation, motor lugging, and motor stalling; and
f. a control circuit operably coupled to the current sensor, to the relay, and to the solid state switch, the control circuit being responsive to the current sensor to selectively direct motor current through the solid state switch during normal motor operation and through the relay during motor lugging and motor stalling.

2. The wiper system of claim 1, the solid state switch comprising a MOSFET having an R_{DS(on)} greater than 30 mOhms.

3. The wiper system of claim 1 further comprising a second solid state switch in the power circuit, the second solid state switch responsive to commands from the control circuit to shunt reverse currents from the motor when the motor is switched.

4. A method of controlling an electric motor comprising the steps of:
a. selectively supplying motor current from a vehicle power source to the motor through one or both of a relay and a solid state switch;
b. sensing changes in the motor current associated with normal motor operation, motor lugging, and motor stalling; and
c. controlling the relay and the solid state switch in response to the sensed changes in motor current; and
d. supplying motor current from the vehicle power source through the solid state switch during normal motor operation and through the relay during motor lugging and motor stalling.

5. The method of claim 4, further comprising the step of periodically opening and closing the relay to clean the relay contacts.

6. The method of claim 4 wherein the electric motor is a wiper motor.

7. The method of claim 4 wherein the electric motor is a power window motor.
